(19) United States
(12) Patent Application Publication
(10) Pub. No.: US 2008/0263846 A1
(43) Pub. Date: Oct. 30, 2008

(54) Fastening mechanism

(75) Inventor: Yung-Chung Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei City (TW)

(21) Appl. No.: 11/796,225

(22) Filed: Apr. 26, 2007

(51) Int. Cl. B29D 5/00

(52) U.S. Cl. 29/410

(57) ABSTRACT

A fastening mechanism for use in an electronic device, including: a box with two side walls each provided with a first guiding groove formed with a through-hole and a second guiding groove; two fastening elements matching the second guiding grooves; and two resilient positioning elements disposed on the two fastening elements respectively and corresponding in position to the through-hole, wherein at least one of the two resilient positioning elements corresponds in position to the through-hole and includes a positioning portion. Users render the resilient positioning element resiliently compressed by pressing on the positioning portion of resilient positioning element, and slidingly dispose the positioning portion of the resiliently compressed resilient positioning element in the first guiding groove by insertably engaging the fastening element to the second guiding groove, such that the positioning portion is insertably engaged to the through-hole as soon as the positioning portion corresponds in position to the through-hole.

### BACKGROUND OF THE INVENTION

1. Field of the Invention

The present invention relates to fastening mechanisms, and more particularly, to a fastening mechanism for fastening an electronic device to a casing.

2. Description of the Prior Art

Electronic apparatus nowadays is assembled mainly by putting delicate components and devices inside the casing of the host. For instance, a computer is assembled by installing essential parts, such as a motherboard, hard disk drive, CD-ROM drive, and power supply, in the casing. A fixing means nowadays entails screwing, for example, a hard disk drive or CD-ROM drive, to the casing with a screwdriver or an equivalent thereof. In the event that a user does not have any screwdriver or a similar tool at hand, the user will find it difficult to assemble a computer. On the other hand, changing a hard disk drive or CD-ROM drive already fastened to the casing entails unscrewing the hard disk drive or CD-ROM drive with a screwdriver or a similar tool, which is rather inconvenient and time-consuming. Accordingly, an issue calling for an urgent solution involves devising a fastening mechanism for solving the aforesaid drawbacks of the prior art.

### SUMMARY OF THE INVENTION

In light of the aforesaid drawbacks of the prior art, it is a primary objective of the present invention to disclose a fastening mechanism conducive to ease of assembly and disassembly.

Another objective of the present invention is to disclose a fastening mechanism for assembling electronic devices.

In order to achieve the above and other objectives, the present invention discloses a fastening mechanism for rapidly fastening accessories of an electronic device to the casing thereof and conveniently unfastening the accessories of the electronic device.

The fastening mechanism of the present invention comprises: a box with two side walls each provided with a first guiding groove extending from the front to the rear of the box and a second guiding groove corresponding in position to the first guiding groove, wherein at least one of the first guiding grooves is formed with a through-hole perpendicularly penetrating the related one of the two side walls of the box; two fastening elements matching the second guiding grooves and disposed on two side walls of the electronic device respectively; and two resilient positioning elements disposed on the two fastening elements respectively and corresponding in position to the through-hole of first guiding groove of the box, wherein at least one of the two resilient positioning elements corresponds in position to the through-hole of first guiding groove of the box and comprises a positioning portion; wherein the fastening mechanism allows users to render the resilient positioning element resiliently compressed by pressing on the positioning portion of resilient positioning element, and slidingly dispose the positioning portion of the resiliently compressed resilient positioning element in the first guiding groove by insertably engaging the fastening element to the second guiding groove of the box, such that the positioning portion is insertably engaged to the through-hole of first guiding groove under resilience of the resilient positioning element as soon as the positioning portion corresponds in position to the through-hole of first guiding groove, thus fastening the electronic device in the box.

Preferably, the fastening elements are implemented by two fastening plates, the positioning elements by screws, and the resilient positioning elements by thumbscrews capable of resilient extension and contraction. Each of the first guiding grooves is internally provided with a third guiding groove. The third guiding groove is narrower than the first guiding groove. The fastening mechanism further comprises at least one second positioning element matching the first guiding grooves in width. The fastening mechanism further comprises at least one second resilient positioning element capable of resilient extension and contraction. A second through-hole corresponding in position to the second resilient positioning element is formed in the third guiding groove. The second resilient positioning element is insertably engaged to the second through-hole as soon as an intended device is secured in position.

Unlike the prior art that teaches fastening an electronic device to the casing thereof by means of a plurality of screws, the present invention has an advantage, that is, fast, time-saving assembly and disassembly of an electronic device.

Accordingly, the fastening mechanism of the present invention solves the drawbacks of the prior art and enables fast, time-saving assembly and disassembly of an electronic device.

### BRIEF DESCRIPTION OF THE DRAWINGS

FIG. 1 is an exploded view showing the first preferred embodiment of the fastening mechanism of the present invention;

FIG. 2 is a perspective view showing the first preferred embodiment of the fastening mechanism of the present invention when assembled;

FIG. 3 is an end cross-sectional view showing a thumbscrew capable of resilient extension and contraction in accordance with the present invention;

FIG. 4a is a top plan view showing the first preferred embodiment of the fastening mechanism of the present invention before putting an intended device into the box;

FIG. 4b is a top plan view showing the first preferred embodiment of the fastening mechanism of the present invention while putting an intended device into the box;

FIG. 4c is a top plan view showing the first preferred embodiment of the fastening mechanism of the present invention after securing in position an intended device in the box;

FIG. 5 is an exploded view showing the second preferred embodiment of the fastening mechanism of the present invention;

FIG. 6a is a top plan view showing the second preferred embodiment of the fastening mechanism of the present invention before putting an intended device into the box;

FIG. 6b is a top plan view showing the second preferred embodiment of the fastening mechanism of the present invention while putting an intended device into the box;

FIG. 6c is a top plan view showing the second preferred embodiment of the fastening mechanism of the present invention after securing in position an intended device in the box;

FIG. 7 is an exploded view showing the third preferred embodiment of the fastening mechanism of the present invention; and

FIG. 8 is an exploded view showing the fourth preferred embodiment of the fastening mechanism of the present invention.

### DETAILED DESCRIPTION OF THE PREFERRED EMBODIMENTS

The following specific embodiments are provided to illustrate the present invention. Persons skilled in the art can readily gain insight into other advantages and features of the present invention based on the contents disclosed in this specification.

Points to note are as follows: all the accompanying drawings are simple schematic diagrams intended to schematically describe the basic structure of the present invention. Hence, in the drawings, only those components related to the present invention are shown, and the shown components are not drawn according to their actual quantity, shape and dimensions when implemented; in practice, the specifications, quantity, and dimensions of the components may be devised as appropriate, without being limited by the present invention.

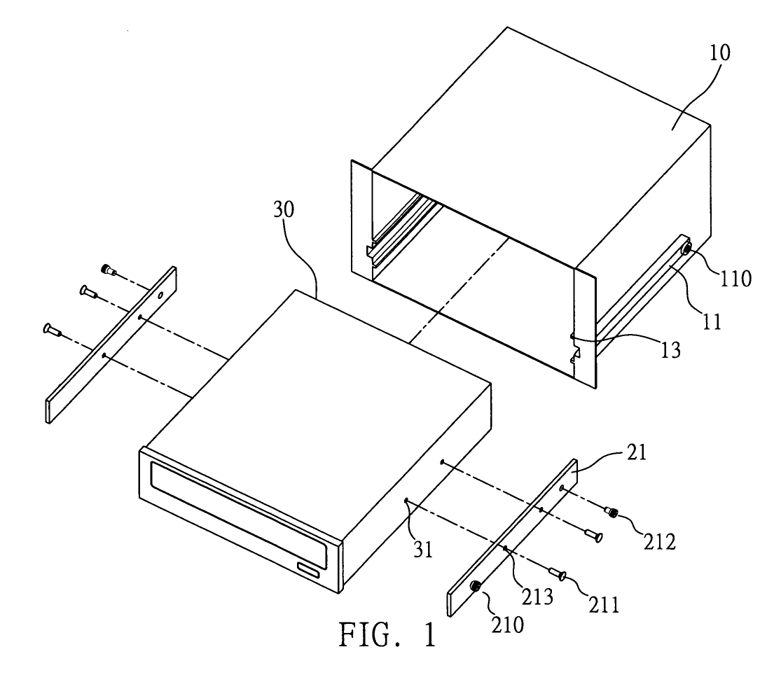

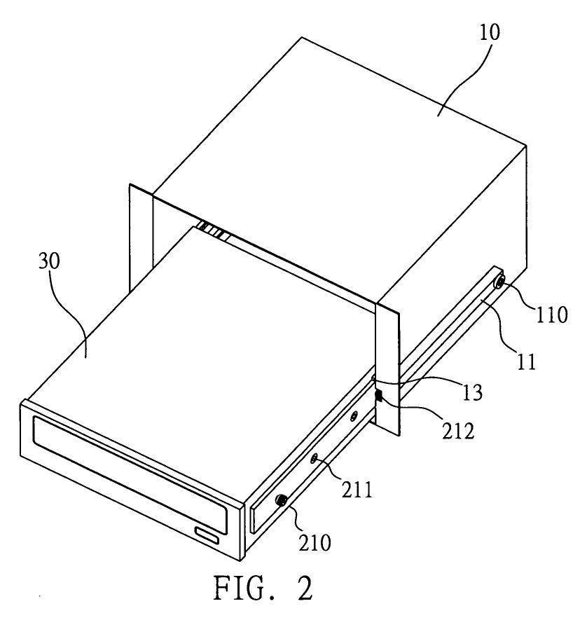

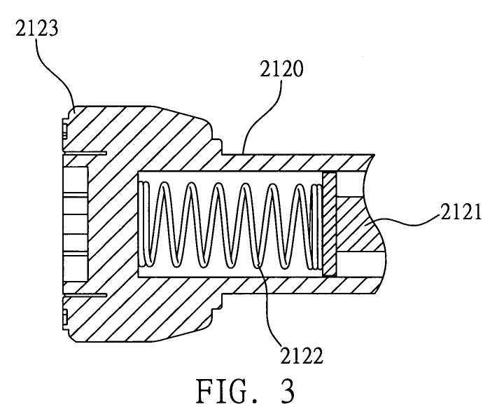

FIGS. 1 and 2 are schematic views showing the first preferred embodiment of the fastening mechanism of the present invention. The first preferred embodiment of the fastening mechanism of the present invention comprises: a box 10 with two side walls each provided with a first guiding groove 11 extending from the front to the rear of the box 10 and a second guiding groove 13 corresponding in position to the first guiding groove 11, wherein one end of the first guiding groove 11 is internally provided with a through-hole 110 penetrating the first guiding groove 11 and the related one of the two side walls of the box 10; and two fastening elements constructed as fastening plates 21 each formed with two fastening holes 213 and one positioning element. In the first preferred embodiment, the positioning element is constructed as a positioning screw 210. The fastening plates 21 are screwed to a CD-ROM drive 30 bilaterally, using screws 211 that penetrate the fastening holes 213. A resilient positioning element is disposed on each of the fastening plates 21 and corresponds in position to the through-hole 110 in the first guiding groove 11 of the box 10. In the first preferred embodiment, the resilient positioning element is a thumbscrew 212 capable of resilient extension and contraction. Referring to FIG. 3, the thumbscrew 212 comprises a first housing 2120 and a second housing 2121. Insertably coupled to the second housing 2121, the first housing 2120 is formed with a positioning portion 2123 and internally provided with a spring 2122. The first housing 2120 and second housing 2121 are pressed against and then released from one another by means of the spring 2122. In the first preferred embodiment, the through-hole 110 and the thumbscrew 212 capable of resilient extension and contraction are positioned at the first guiding grooves 11 and the rear of the fastening plates 21. An intended electronic device is secured in position to the box 10, using the fastening plates 21. In the preferred embodiment, the intended electronic device is the CD-ROM drive 30. Four fastening elements (i.e., the screws 211 in the first preferred embodiment) penetrate the four fastening holes 213 of the fastening plates 21 and the fastening screw holes 31 of the CD-ROM drive 30 respectively, thus screwing the CD-ROM drive 30 and the two fastening plates 21 together. After screwing the CD-ROM drive 30 and the two fastening plates 21 together, the fastening plates 21 are inserted into the box 10 and engaged thereto, by insertably engaging the positioning screws 210 and the thumbscrew 212 resiliently compressed and capable of resilient extension and contraction to the first guiding groove 11 of the box 10, and by insertably engaging the fastening plates 21 to the second guiding grooves 13. Once the CD-ROM drive 30 and fastening plates 21 reach a predetermined position, or in other words, once the thumbscrew 212 reaches the through-hole 110 in the first guiding groove 11, the resiliently compressed thumbscrew 212 will be restored to the original state thereof and insertably engaged to the through-hole 110 in the first guiding groove 11 of the box 10.

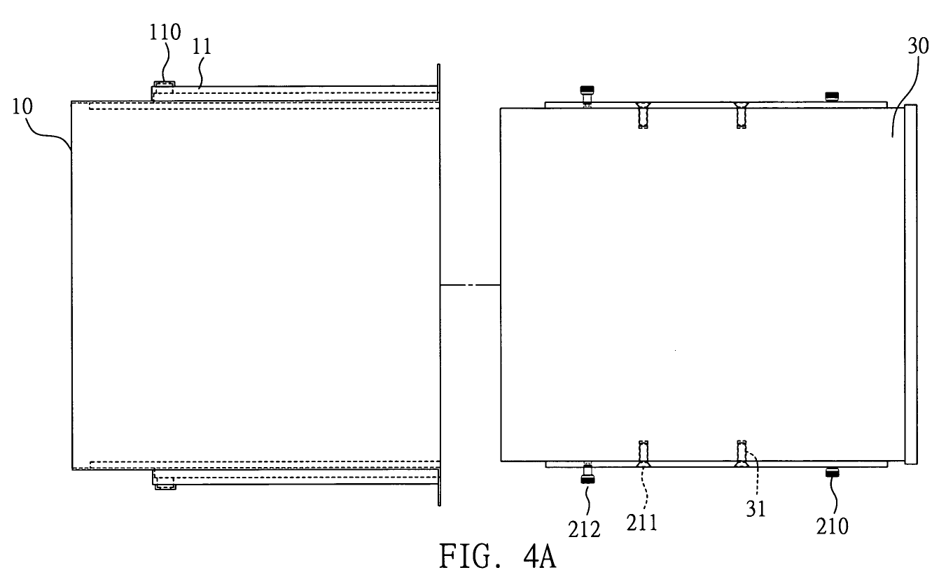

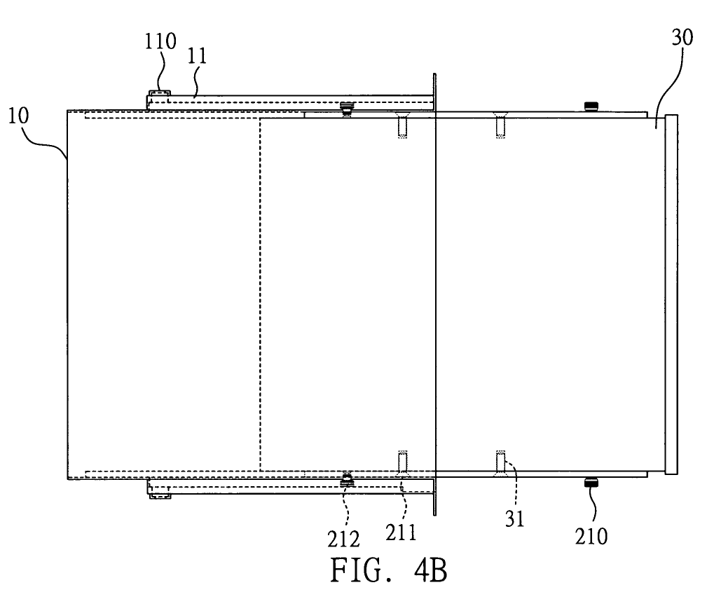

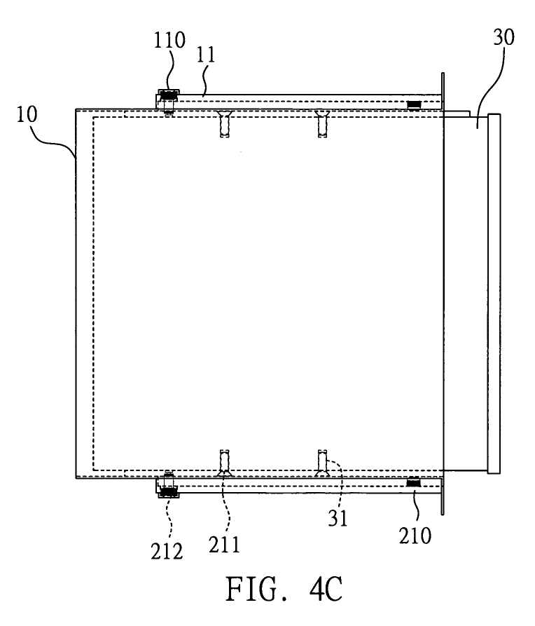

Referring to FIGS. 4a, 4b and 4c, after the CD-ROM drive 30 and the two fastening plates 21 have been screwed together, the CD-ROM drive 30 and the two fastening plates 21 are allowed to lie flat, and the thumbscrews 212 are aligned with the first guiding grooves 11 of the box 10 respectively. Referring to FIG. 4a, at this point, the thumbscrews 212 have not yet contracted, and the thumbscrews 212 are longer than the positioning screws 210. Referring to FIG. 4b, pressing on both the thumbscrews 212 and pushing the thumbscrews 212 into the first guiding grooves 11 of the box 10 insertably engages the thumbscrews 212 to the first guiding grooves 11 and allows the thumbscrews 212 to equal, roughly, the positioning screws 210 in length. Referring to FIG. 4c, once the CD-ROM drive 30 and the two fastening plates 21 reach the intended position, the springs 2122 of thumbscrews 212 restore the resiliently compressed thumbscrews 212 to the original state thereof, thus insertably engaging the thumbscrews 212 to the through-holes 110 at the rear of the first guiding grooves 11 of the box 10. At this point, the CD-ROM drive 30 is secured in position to the box 10. To remove the CD-ROM drive 30 from the box 10, a user has to press on the thumbscrews 212 to withdraw the thumbscrews 212 from the through-holes 110, and then pull the CD-ROM drive 30. The present invention is time-saving in assembly and disassembly, compared to the prior art.

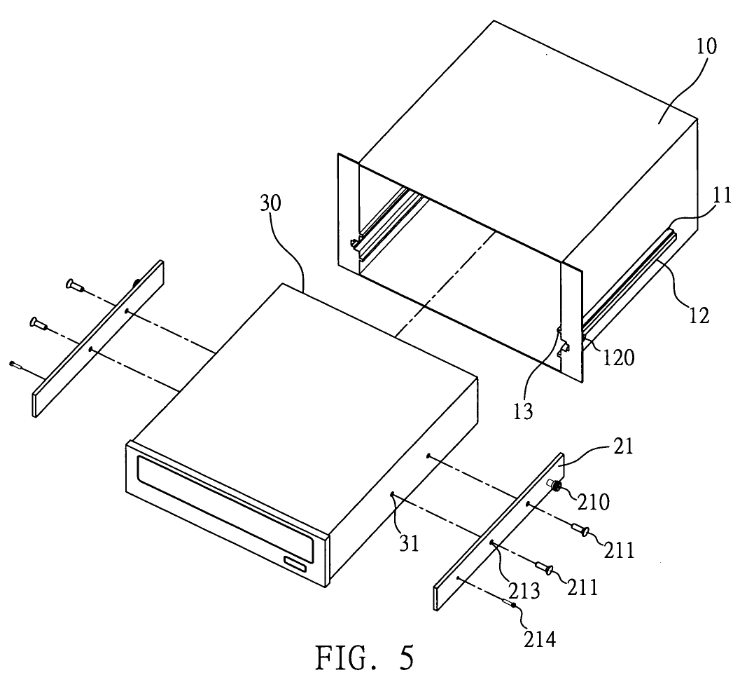

Referring to FIG. 5, the second preferred embodiment of the fastening mechanism of the present invention comprises: a box 10 with two side walls each provided with a first guiding groove 11 extending from the front to the rear of the box 10 and a second guiding groove 13 corresponding in position to the first guiding groove 11; and two fastening elements. Each of the first guiding grooves 11 is internally provided with a third guiding groove 12. The third guiding grooves 12 are narrower than the first guiding grooves 11. One end of each of the third guiding grooves 12 is internally provided with a second through-hole 120 penetrating the third guiding groove 12 and the related one of the two side walls of the box 10. In the second preferred embodiment, the two fastening elements are constructed as the fastening plates 21 each formed with the two fastening holes 213 and the positioning element. The fastening plates 21 are screwed to the CD-ROM drive 30 bilaterally, using the screws 211 penetrating the fastening holes 213. In the second preferred embodiment, the positioning elements are constructed as the positioning screws 210, and the positioning screws 210 match the first guiding grooves 11 in width. A second resilient positioning element is disposed on the fastening plate 21 and corresponds in position to the second through-hole 120 in the third guiding groove 12 of the box 10. In the second preferred embodiment, the second resilient positioning element is a thumbscrew 214 capable of resilient extension and contraction, and the thumbscrew 214 matches the third guiding groove 12 in width. Referring to FIG. 3, the thumbscrew 214 is structurally identical to the thumbscrew 212, but the dimensions of the thumbscrew 214 are less than that of the thumbscrew 212. In the second preferred embodiment, the second through-hole 120 and the thumbscrew 214 capable of resilient extension and contraction are positioned at the third guiding grooves 12 and the front of the fastening plates 21. The CD-ROM drive 30 is secured in position to the box 10, using the fastening plates 21. The four screws 211 penetrate the four fastening holes 213 of the fastening plates 21 and the fastening screw holes 31 of the CD-ROM drive 30 respectively, thus screwing the CD-ROM drive 30 and the two fastening plates 21 together. After screwing the CD-ROM drive 30 and the two fastening plates 21 together, the fastening plates 21 are inserted into the box 10 and engaged thereto, by insertably engaging the positioning screws 210 to the first guiding grooves 11 of the box 10, by insertably engaging the resiliently compressed thumbscrew 214 to the third guiding groove 12, and by insertably engaging the fastening plates 21 to the second guiding grooves 13. Once the CD-ROM drive 30 and fastening plates 21 reach a predetermined position, or in other words, once the thumbscrew 214 reaches the second through-hole 120 in the third guiding groove 12, the resiliently compressed thumbscrew 214 will be restored to the original state thereof and insertably engaged to the second through-hole 120 in the third guiding groove 12 of the box 10.

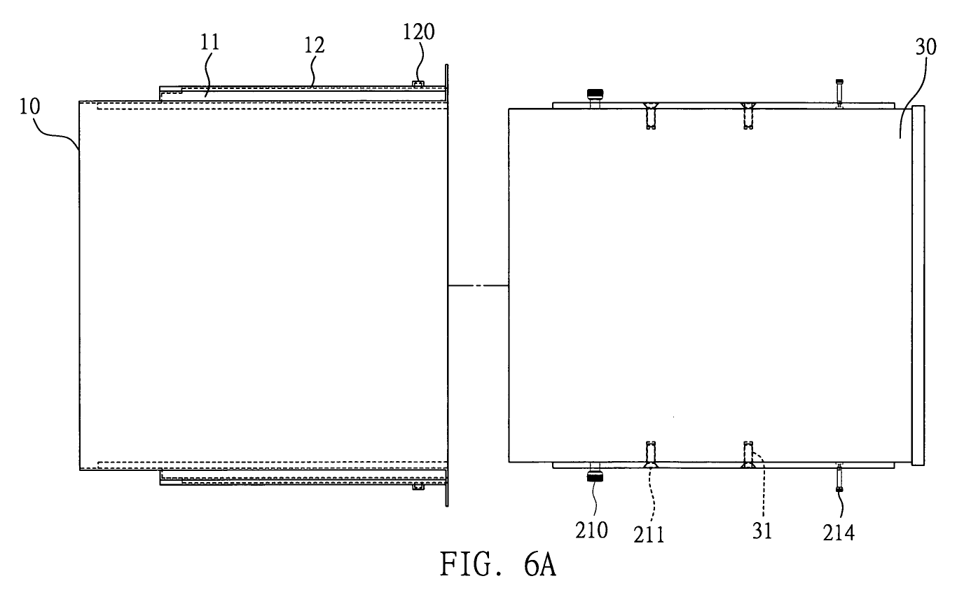

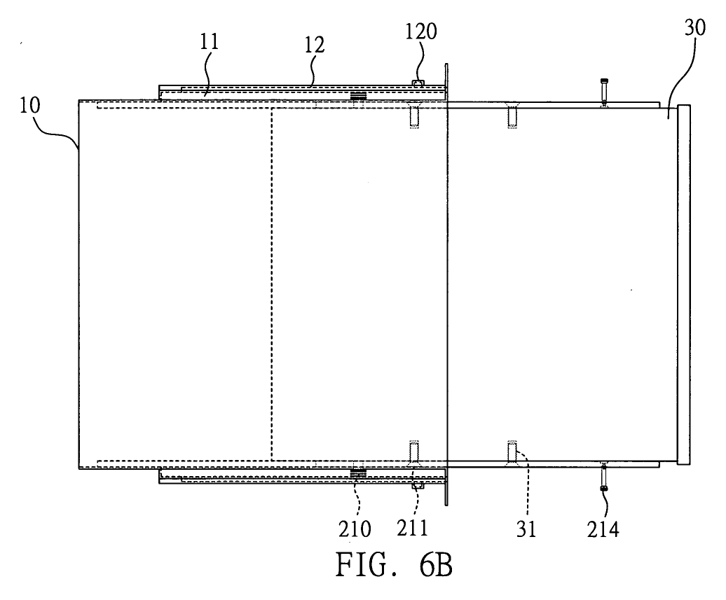

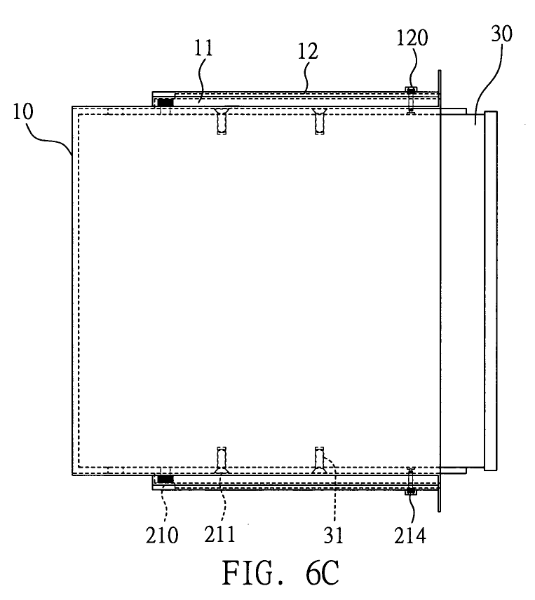

Referring to FIGS. 6a, 6b and 6c, after the CD-ROM drive 30 and the two fastening plates 21 have been screwed together, the CD-ROM drive 30 and the two fastening plates 21 are allowed to lie flat, and the positioning screws 210 are aligned with the first guiding grooves 11 of the box 10 respectively. Referring to FIG. 6a, at this point, the thumbscrews 214 have not yet contracted, and the thumbscrews 214 are longer than the positioning screws 210. Referring to FIG. 6b, the positioning screws 210 aligned with the first guiding grooves 11 are pushed into the first guiding grooves 11, thus insertably engaging the positioning screws 210 to the first guiding grooves 11 respectively and bilaterally. Referring to FIG. 6c, once the pressed thumbscrews 214 are pushed into the third guiding grooves 12 and the CD-ROM drive 30 and the two fastening plates 21 reach the intended position, the springs of thumbscrews 214 restore the resiliently compressed thumbscrews 214 to the original state thereof, thus insertably engaging the thumbscrews 214 to the second through-holes 120 at the front of the third guiding grooves 12 of the box 10. At this point, the CD-ROM drive 30 is secured in position to the box 10. To remove the CD-ROM drive 30 from the box 10, a user has to press on the thumbscrews 214 to withdraw the thumbscrews 214 from the second through-holes 120, and then pull the CD-ROM drive 30 as soon as the aforesaid insertable engagement ceases.

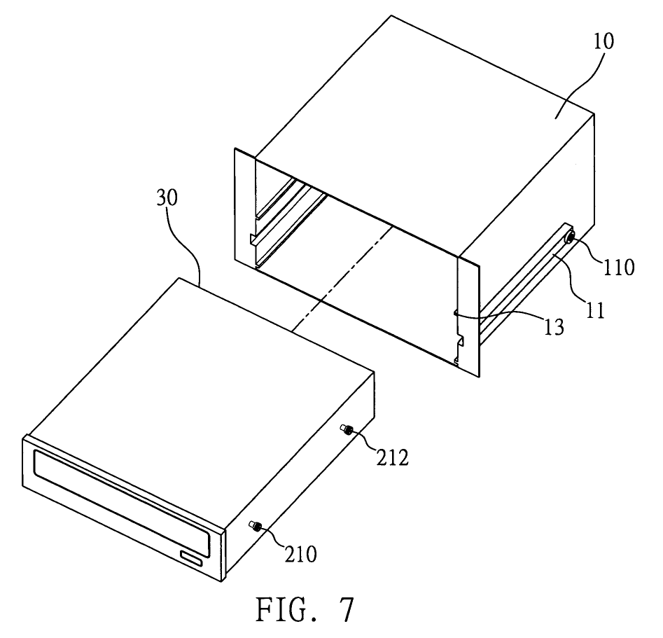

Referring to FIG. 7, the third preferred embodiment of the fastening mechanism of the present invention comprises: a box 10 with two side walls each provided with a first guiding groove 11 extending from the front to the rear of the box 10 and a second guiding groove 13 corresponding in position to the first guiding groove 11, wherein at least one of the first guiding grooves 11 is provided with a through-hole 110 perpendicularly penetrating the related one of the two side walls of the box 10; and two resilient positioning elements 212, wherein at least one of the two resilient positioning elements 212 corresponds in position to the through-hole 110 of first guiding groove 11 of the box 10 and comprises a positioning portion 2123. The two resilient positioning elements 212 are disposed at the through-holes 110 in the first guiding grooves 11 corresponding in position to an electronic device (i.e., the CD-ROM drive 30 in the third preferred embodiment) respectively and bilaterally. The fastening mechanism allows users to render the resilient positioning elements 212 resiliently compressed by pressing on the positioning portion 2123 of resilient positioning elements 212, and slidingly dispose the positioning portions 2123 of the resiliently compressed resilient positioning elements 212 in the first guiding grooves 11 by insertably engaging the electronic device (i.e., the CD-ROM drive 30 in the third preferred embodiment) to the second guiding grooves 13 of the box 10, such that the positioning portions 2123 are insertably engaged to the through-holes 110 of first guiding grooves 11 under resilience of the resilient positioning elements 212 as soon as the positioning portions 2123 corresponds in position to the through-holes 110 of first guiding grooves 11, thus fastening the CD-ROM drive 30 in the box 10. The actuation of the third preferred embodiment is the same as that of the first preferred embodiment and second preferred embodiment, as shown in FIGS. 4a-4c, and FIGS. 6a-6c.

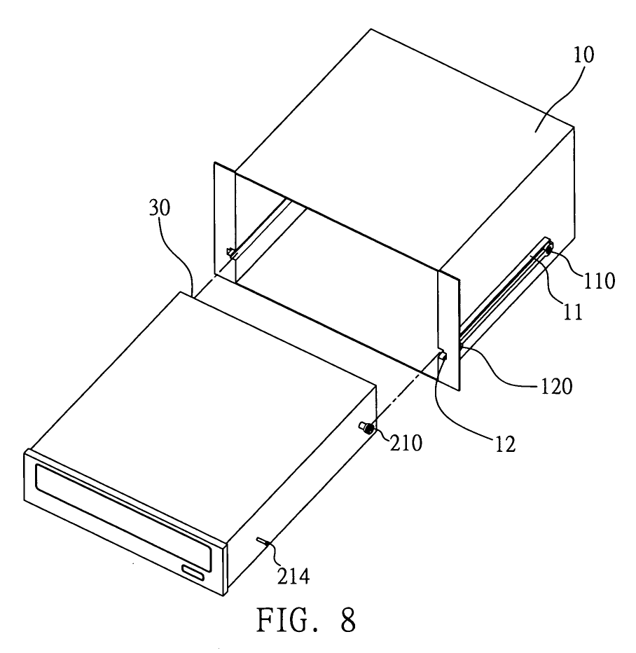

Referring to FIG. 8, the fourth preferred embodiment of the fastening mechanism of the present invention comprises: a box 10 with two side walls each provided with a first guiding groove 11 extending from the front to the rear of the box 10; and two positioning elements (i.e., the positioning screws 210) provided for the CD-ROM drive 30 bilaterally, wherein the positioning screws 210 match the first guiding grooves 11 in width. In the fourth preferred embodiment, each of the first guiding grooves 11 is internally provided with the third guiding groove 12, and the third guiding grooves 12 are narrower than the first guiding grooves 11. One end of each of the third guiding grooves 12 is internally provided with the second through-hole 120 penetrating the third guiding groove 12 and the related one of the side walls of the box 10. A second resilient positioning element is disposed at the CD-ROM drive 30 and corresponds in position to the second through-hole 120 in the third guiding groove 12 of the box 10. In the fourth preferred embodiment, the second resilient positioning element is a thumbscrew 214 capable of resilient extension and contraction, and the thumbscrew 214 matches the third guiding groove 12 in width. Referring to FIG. 3, the thumbscrew 214 is structurally identical to the thumbscrew 212, but the dimensions of the thumbscrew 214 are less than that of the thumbscrew 212. In the fourth preferred embodiment, the second through-hole 120 and the thumbscrew 214 capable of resilient extension and contraction are positioned at the third guiding grooves 12 and the front of the CD-ROM drive 30. The CD-ROM drive 30 is inserted into the box 10 and engaged thereto, by insertably engaging the positioning screws 210 to the first guiding grooves 11 of the box 10, and by insertably engaging the resiliently compressed thumbscrew 214 to the third guiding groove 12. Once the CD-ROM drive 30 and fastening plates 21 reach a predetermined position, or in other words, once the thumbscrew 214 reaches the second through-hole 120 in the third guiding groove 12, the resiliently compressed thumbscrew 214 will be restored to the original state thereof and insertably engaged to the second through-hole 120 in the third guiding groove 12 of the box 10. The actuation of the fourth preferred embodiment is the same as that of the first preferred embodiment and second preferred embodiment, as shown in FIGS. 4a-4c, and FIGS. 6a-6c.

Unlike the screwing-based prior art, the present invention discloses insertable engagement of resilient screws and through-holes in the box, thus sparing the multiple screwing processes, reducing the time spent on assembly and disassembly, and solving the drawbacks of the prior art.

Accordingly, the fastening mechanism of the present invention sufficiently overcomes the drawbacks of the prior art and thereby has high industrial applicability.

The aforesaid embodiments merely serve as the preferred embodiments of the present invention. The aforesaid embodiments should not be construed as to limit the scope of the present invention in any way. Hence, many other changes can actually be made in the present invention. It will be apparent to those skilled in the art that all equivalent modifications or changes made to the present invention, without departing from the spirit and the technical concepts disclosed by the present invention, should fall within the scope of the appended claims.

What is claimed is:

1. A fastening mechanism for use in an electronic device, comprising:
a box with two side walls each provided with a first guiding groove extending from the front to the rear of the box and a second guiding groove corresponding in position to the first guiding groove, wherein at least one of the first guiding grooves is formed with a through-hole perpendicularly penetrating the related one of the two side walls of the box;
two fastening elements matching the second guiding grooves and disposed on two side walls of the electronic device respectively; and
two resilient positioning elements disposed on the two fastening elements respectively and corresponding in position to the through-hole of first guiding groove of the box, wherein at least one of the two resilient positioning elements corresponds in position to the through-hole of first guiding groove of the box and comprises a positioning portion;
wherein the fastening mechanism allows users to render the resilient positioning element resiliently compressed by pressing on the positioning portion of resilient positioning element, and slidingly dispose the positioning portion of the resiliently compressed resilient positioning element in the first guiding groove by insertably engaging the fastening element to the second guiding groove of the box, such that the positioning portion is insertably engaged to the through-hole of first guiding groove under resilience of the resilient positioning element as soon as the positioning portion corresponds in position to the through-hole of first guiding groove, thus fastening the electronic device in the box.

2. The fastening mechanism of claim 1, wherein the fastening elements are fastening plates.

3. The fastening mechanism of claim 1, wherein the fastening elements are screwed to the two side walls of the electronic device.

4. The fastening mechanism of claim 1, wherein the resilient positioning elements are thumbscrews capable of resilient extension and contraction.

5. The fastening mechanism of claim 1, further comprising at least one positioning element matching the first guiding groove in width, disposed at one of the fastening elements, and spaced from one of the two resilient positioning elements by a predetermined distance.

6. The fastening mechanism of claim 1, wherein each of the first guiding grooves is internally provided with a third guiding groove, wherein the third guiding groove is narrower than the first guiding groove and penetrated by an aperture.

7. The fastening mechanism of claim 6, further comprising at least one second resilient positioning element matching the third guiding groove in width, disposed at one of the fastening elements and corresponding in position to the aperture, and spaced from one of the two resilient positioning elements by a predetermined distance.

8. The fastening mechanism of claim 7, wherein the second resilient positioning element is a thumbscrew capable of resilient extension and contraction.

9. A fastening mechanism for use in an electronic device, comprising:
a box with two side walls each provided with a first guiding groove extending from the front to the rear of the box and a second guiding groove corresponding in position to the first guiding groove, wherein at least one of the first guiding grooves is formed with a through-hole perpendicularly penetrating the related one of the two side walls of the box; and
two resilient positioning elements disposed on the electronic device and corresponding in position to the through-hole of first guiding groove of the box, wherein at least one of the two resilient positioning elements corresponds in position to the through-hole of first guiding groove of the box and comprises a positioning portion;
wherein the fastening mechanism allows users to render the resilient positioning element resiliently compressed by pressing on the positioning portion of resilient positioning element, and slidingly dispose the positioning portion of the resiliently compressed resilient positioning element in the first guiding groove by insertably engaging the electronic device to the second guiding groove of the box, such that the positioning portion is insertably engaged to the through-hole of first guiding groove under resilience of the resilient positioning element as soon as the positioning portion corresponds in position to the through-hole of first guiding groove, thus fastening the electronic device in the box.

10. The fastening mechanism of claim 9, wherein the resilient positioning elements are thumbscrews capable of resilient extension and contraction.

11. The fastening mechanism of claim 9, further comprising at least one positioning element matching the first guiding groove in width, disposed at one of the fastening elements, and spaced from one of the two resilient positioning elements by a predetermined distance.

12. The fastening mechanism of claim 9, wherein each of the first guiding grooves is internally provided with a third guiding groove, wherein the third guiding groove is narrower than the first guiding groove and penetrated by an aperture.

13. The fastening mechanism of claim 12, further comprising at least one second resilient positioning element matching the third guiding groove in width, disposed at one of the fastening elements and corresponding in position to the aperture, and spaced from one of the two resilient positioning elements by a predetermined distance.

14. The fastening mechanism of claim 13, wherein the second resilient positioning element is a thumbscrew capable of resilient extension and contraction.

15. A fastening mechanism for use in an electronic device, comprising:
a box with two side walls each provided with a first guiding groove extending from the front to the rear of the box, wherein at least one of the first guiding grooves is formed with a through-hole perpendicularly penetrating the related one of the two side walls of the box;
two positioning elements matching the first guiding grooves in width and disposed on two side walls of the electronic device respectively; and
two resilient positioning elements disposed on the electronic device, corresponding in position to the through-hole of first guiding groove of the box, and spaced from the positioning elements respectively by a predetermined distance, wherein at least one of the two resilient positioning elements corresponds in position to the through-hole of first guiding groove of the box and comprises a positioning portion;
wherein the fastening mechanism allows users to render the resilient positioning element resiliently compressed by pressing on the positioning portion of resilient positioning element, and slidingly dispose the positioning portion of the resiliently compressed resilient positioning element in the first guiding groove by insertably engaging the positioning element and resilient positioning element to the first guiding groove of the box, such that the positioning portion are insertably engaged to the through-hole of first guiding groove under resilience of the resilient positioning element as soon as the positioning portion corresponds in position to the through-hole of first guiding groove, thus fastening the electronic device in the box.

16. The fastening mechanism of claim 15, wherein the resilient positioning elements are thumbscrews capable of resilient extension and contraction.

17. The fastening mechanism of claim 15, wherein each of the first guiding grooves is internally provided with a third guiding groove, wherein the third guiding groove is narrower than the first guiding groove and penetrated by an aperture.

18. The fastening mechanism of claim 17, further comprising at least one second resilient positioning element matching the third guiding groove in width, disposed at one of the fastening elements and corresponding in position to the aperture, and spaced from one of the two resilient positioning elements by a predetermined distance.

19. The fastening mechanism of claim 18, wherein the second resilient positioning element is a thumbscrew capable of resilient extension and contraction.
